(19) United States
(12) Patent Application Publication
(10) Pub. No.: US 2023/0131754 A1
(43) Pub. Date: Apr. 27, 2023

(54) Biomass Direct Reduced Iron

(71) Applicant: Technological Resources Pty. Limited, Melbourne, VIC (AU)

(72) Inventors: Rodney James Dry, City Beach (AU); Michael Buckley, Mosman Park (AU)

(21) Appl. No.: 17/913,116

(22) PCT Filed: Mar. 19, 2021
(86) PCT No.: PCT/AU2021/050252

§ 371 Date: Sep. 20, 2022

(30) Foreign Application Priority Data
Mar. 20, 2020 (AU) 2020900862

(51) Int. Cl. C21B 13/00; C21B 13/14; C21B 13/12

(52) U.S. Cl. CPC C21B 13/008; C21B 13/14; C21B 13/12; C21B 13/0006; C21B 2100/80

(57) ABSTRACT

A process and an apparatus for producing direct reduced iron (“DRI”) from iron ore and biomass are disclosed. The process includes heating a batch of iron ore and biomass in a batch oven (3) and reducing iron ore and forming a solid DRI product having a metallisation of 80-99% and generating an offgas. The process includes discharging the solid product at the end of the batch cycle and discharging offgas during the course of the batch cycle. The process operates the batch oven in a temperature range of 700-1100#C in a batch cycle time of 10-100 hours.

### TECHNICAL FIELD

The present invention relates to a process and an apparatus for producing direct reduced iron (“DRI”) from iron ore and biomass.

The present invention relates particularly to a process and an apparatus for producing DRI in multiple static batch ovens. This DRI may be used to make hot metal, cold pig iron or steel in an electric melting furnace.

The term “direct reduced iron (“DRI”)” is understood herein to mean iron produced from the direct reduction of iron ore (in the form of lumps, pellets, briquettes or fines) to iron by a reducing gas at temperatures below the bulk melting temperature of the solids.

The present invention also relates to a process and apparatus for producing molten metal (such as cold pig iron or steel) from DRI.

### BACKGROUND

Climate change is driving a fundamental re-evaluation of future options for producing iron and steel.

Blast furnaces currently dominate virgin iron production and emit very high levels of CO₂, roughly 1.8-2.0 t CO₂ per tonne of pig iron.

One alternative to blast furnaces is conversion of renewable (green) energy into hydrogen (particularly in periods when wind/solar power cost is low), with subsequent production of DRI (using hydrogen) followed by smelting in an EAF to produce steel. This route has strong support (particularly in Europe) and has the potential to become a significant part of the global solution (1). However, it has limitations, such as:
1. The amount of electricity needed is high (3000-4000 kWh/t) and green power cost needs to be low (or carbon tax high) for it to become cost-effective.
2. Storage and supply of large amounts of hydrogen is a technical challenge. Underground salt caverns and exhausted natural gas reservoirs appear to show good potential. However, not all geographical locations may be amenable to this type of hydrogen storage. Moreover, suitable storage locations may not be close to logistics facilities for existing blast furnaces, resulting in supply challenges.
3. Only low-gangue ore types can be used with this combination. The EAF will penalise high gangue ore types strongly, rendering them essentially non-competitive. This implies most of the ore currently used in blast furnaces could become sub-economic for this process route.

It is well known that biomass can be a complementary part of the solution.

However, previous attempts to insert some biomass into processes originally designed for coal (e.g. blast furnaces and coke ovens) are marginal at best and usually quite disappointing in terms of overall CO₂ impact. This is largely because the nature of biomass is vastly different to that of coal. To use biomass successfully it is necessary to re-design the process around the fundamental nature of biomass.

Biomass can take many forms (examples include elephant grass, sugar cane bagasse, wood waste, excess straw, azolla and seaweed). Avoiding competition with food production is a key issue. Biomass availability varies considerably from one geographic location to another—this will most likely be a significant factor determining the size and location of future biomass-based iron plants.

Various lab-scale studies (2) have shown that iron ores tested by mixing the ores with biomass and heating the mixtures in a small furnace can produce DRI in a manner that appears (superficially) somewhat better than that expected from first principles. Although the reasons may not be clear, the result stands as a technical “sweet spot”. The technical challenge is how to perform this efficiently at large scale.

There are many possible approaches. One of these approaches (currently being developed by the applicant) involves briquetting ore and biomass, then using a linear or rotary heath furnace (or a rotary kiln) to preheat the material to around 800-900° C. to devolatilise it. Ore pre-reduction is expected to reach around 40-70% under these conditions. This is followed by a microwave treatment stage where the briquettes are heated to around 1000-1100° C. and reduced (using residual bio-carbon) further, with reductions typically around 90-95% and in some instances up to almost full metallisation. This DRI may then be fed to an open-arc furnace or an induction furnace to produce pig iron.

The present invention is an alternative approach to the production of DRI.

The above description is not to be taken as an admission of the common general knowledge in Australia or elsewhere.

### SUMMARY OF THE DISCLOSURE

The present invention is based on the use of a batch oven.

More particularly, the present invention is based on a realisation that an adapted form of a non-recovery coke oven can provide an efficient way of heating and reducing ore-biomass briquettes.

In broad terms, the present invention provides a process for producing direct reduced iron (“DRI”) from iron ore and biomass that includes heating a batch of iron ore and biomass in a batch oven in a temperature range of 700-1100° C. in a batch cycle time of 10-100 hours and reducing iron ore and forming a solid DRI product having a metallisation of 80-99%, typically 90-99%, and generating an offgas and discharging the solid product at the end of the batch cycle and discharging offgas during the course of the batch cycle.

The term “metallisation” is understood herein to mean is the extent of conversion of iron oxide into metallic iron during reduction of the iron oxide as a percentage of the mass of metallic iron divided by the mass of total iron.

The term “batch cycle time” is understood herein to mean the time from charging a new batch of feed iron ore and biomass into a batch oven to the time of pushing (essentially all) product out of the oven.

A key feature of the present invention is that it accommodates slow iron ore-biomass heat transfer rates, which are particularly an issue when iron ore and biomass are in the form of briquettes. The present invention allows greatly extended heating times (roughly 100-300 times longer than other options). Temperature driving forces are also lower in such a system, hence a greater proportion of the biomass energy can be captured and used for heating (thereby reducing the need for imported electric power). This translates to higher thermal efficiency and lower overall operating cost compared to other options mentioned above.

An iron ore-biomass briquette process embodiment of the present invention differs from non-recovery coke-making in a number of ways. In particular, biomass contains only about half the calorific value of an equivalent mass of coal. At the portion of biomass to ore in the briquette (typically 30-40% by weight, wet basis), there will be no excess of fuel gas derived from biomass. Available fuel gas will need to be used sparingly—with this in mind, top space burners are fired with either preheated air or oxygen (or a blend of the two). In the case of preheated air, energy (to preheat air) comes from waste (flue) gas. No significant amount of imported supplementary fuel such as natural gas, oil or coal is used (apart from start-up fuel and possibly a small pilot flame amount to satisfy safety concerns).

The batch oven may be a static oven.

The process may include heating the batch of iron ore and biomass via heat generated by the combustion of a fuel gas in a top space of the batch oven.

The process may include heating the batch of iron ore and biomass via heat generated by the combustion of a fuel gas in a bottom space of the batch oven.

The process may include heating the batch of iron ore and biomass via heat generated by the combustion of a fuel gas with a nominally cold oxygen-air mixture with a minimum of 25% oxygen in the air-oxygen mixture (calculated as a mixed stream regardless of whether or not air and oxygen are (a) actually pre-mixed or (b) fed independently as two individual streams to the gas burners).

The process may include heating the batch of iron ore and biomass via heat generated by the combustion of a fuel gas with hot air in a temperature range 400-1200° C.

The process may include heating the batch of iron ore and biomass via heat generated by the combustion of a fuel gas with a combination of hot air (in a temperature range 25-1200° C.) and cold oxygen, where hot air and oxygen are either pre-blended or fed as individual streams to gas burners.

The percentage of biomass in the batch as supplied to the batch oven may be at least 20% by weight on a wet (as-charged) basis of the total weight of the batch.

The percentage of biomass in the batch as supplied to the batch oven may be less than 50% by weight on a wet (as-charged) basis of the total weight of the batch.

The percentage of biomass in the batch as supplied to the batch oven may be 20-50% by weight on a wet (as-charged) basis of the total weight of the batch.

The balance of the batch as supplied to the batch oven may be (a) iron ore and (b) flux/binder materials and (c) optionally carbonaceous material, which may be coal or pre-charred biomass, in an amount of <5% by weight of the total weight of the batch.

The percentage of biomass in the batch as supplied to the batch oven may be 30-40% by weight on a wet (as-charged) basis of the total weight of the batch.

The balance of the batch as supplied to the batch oven may be (a) iron ore and (b) flux/binder materials and (c) optionally carbonaceous material, which may be coal or pre-charred biomass, in an amount of <5% by weight of the total weight of the batch.

The process may include heating iron ore and biomass to a temperature range of 800-1000° C. in the batch cycle time and reducing iron ore to a metallisation of 85-98%.

The batch cycle time may be 20-70 hours.

The batch cycle time may be 30-60 hours.

The iron ore and biomass in the batch of iron ore and biomass may be layered in the batch oven, such that there is at least one layer of iron ore between one preceding and one succeeding layer of biomass.

The iron ore and biomass in the batch of ore and biomass may be premixed when forming the batch to avoid non-uniform reduction zones in the batch in the batch oven.

The batch of ore and biomass may include briquettes of iron ore and biomass to avoid non-uniform reduction zones in the batch in the batch oven.

The process may include transferring the solid product (typically, whilst hot) from the batch oven to an electric melting furnace and processing the solid product in the electric melting furnace and producing molten metal, such as pig iron or steel, and an offgas.

The process may include using the electric arc furnace fuel gas an energy source in the batch oven.

The present invention also provides a process for producing direct reduced iron (“DRI”) from iron ore and biomass that includes operating a plurality of batch ovens in accordance with the process described above using at least a part of an offgas discharged from at least one batch oven as an energy source, i.e. a fuel gas, in at least one other batch oven, and controlling the batch cycles and operating conditions in the batch ovens to balance heat supply and demand requirements across the batch ovens.

The present invention also provides a process for producing molten metal (such as cold pig iron or steel) from DRI that includes operating the process described above and producing a solid DRI product and transferring the solid DRI product to an electric melting furnace and processing the solid product in the electric melting furnace and producing molten metal, such as pig iron or steel.

The present invention also provides an apparatus for producing direct reduced iron (“DRI”) that includes a plurality of batch ovens for producing batches of DRI from batches of iron ore and biomass, a gas collection and gas sharing assembly interconnecting the batch ovens, the gas collection and sharing assembly including a communal header and pipes extending between the batch ovens and the header for supplying fuel gas to the header and supplying fuel gas from the header to the batch ovens.

The present invention also provides an apparatus for producing molten metal (such as cold pig iron or steel) from a solid DRI product includes the apparatus for producing a direct reduced iron (“DRI”) product described above and an electric melting furnace for producing molten metal, such as pig iron or steel from the solid DRI product.

### BRIEF DESCRIPTION OF THE DRAWINGS

The present invention is described further by way of example with reference to the accompanying drawings, of which:

FIG. 1 is a schematic diagram of one embodiment of a process and apparatus for producing direct reduced iron (“DRI”) from iron ore and biomass which includes a plurality of batch ovens; and

FIGS. 2, 3 and 4 are process flowsheet diagrams illustrating one embodiment of a process and apparatus for producing direct reduced iron (“DRI”) from iron ore and biomass in one of the batch ovens of FIG. 1.

### DESCRIPTION OF EMBODIMENTS

As noted above, in broad terms, the present invention provides a process and an apparatus for producing direct reduced iron (“DRI”) from iron ore and biomass that includes heating a batch of iron ore and biomass in a batch oven in a temperature range of 700-1100° C. in a batch cycle time of 10-100 hours and reducing iron ore and forming a solid DRI product having a metallisation of 80-99%, typically 90-99% and generating an offgas and discharging the solid product at the end of the batch cycle and discharging offgas during the course of the batch cycle.

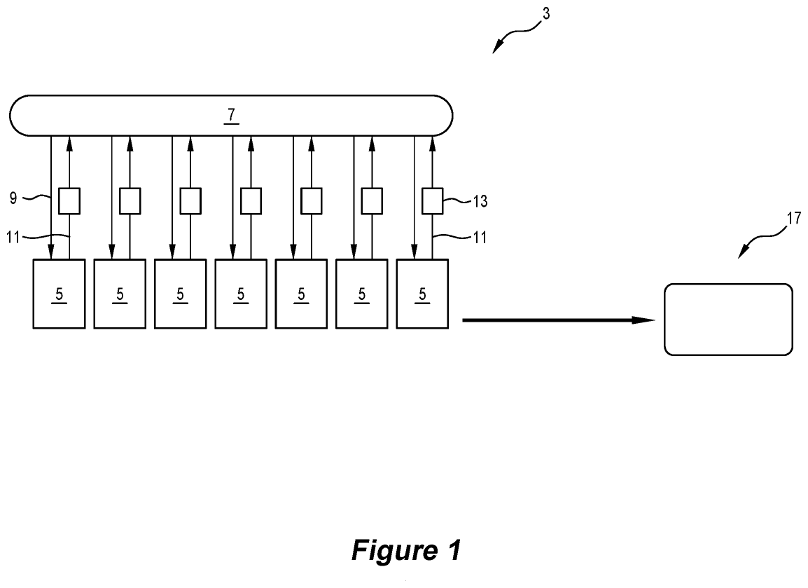

FIG. 1 is a schematic diagram of one embodiment of a process and an apparatus for producing direct reduced iron (“DRI”) from iron ore and biomass which is based on a plurality of batch ovens.

With reference to FIG. 1, the apparatus, generally identified by the numeral 3, includes (a) a plurality of batch ovens 5 arranged in a line and (b) gas collection and sharing assembly, interconnecting the batch ovens 5.

The gas collection and sharing assembly includes a communal header 7 and pipes 9, 11 extending between the batch ovens 5 and the header 7 for supplying fuel gas to the header and supplying fuel gas from the header to the batch ovens as required. The pipes 9 can supply fuel gas from the batch ovens 5 to the header 7. The pipes 11 can supply fuel gas from the header 7 to the batch ovens 5.

In use, batch ovens 5 that are in early (and also possibly in late) parts of a batch cycle receive fuel gas from other batch ovens 5 via the header 7 and pipes 9.

In addition, in use, batch ovens 5 that are in middle (fuel-rich) parts of the cycle transfer fuel gas from the batch ovens 5 via the pipes 11 to the header 7. This fuel gas will be hot at the extraction point, and therefore the gas collection and sharing equipment includes a cooling element 13 that cools the fuel gas before it is admitted into the communal gas sharing system in the header 7.

The cooling element 13 may be any suitable cooling element. By way of example, the cooling element may be in the form of a wet scrubber or an indirect heat exchanger (e.g. long pipes with water or air cooling on the outside). Typically, the header 7 and heat exchanger include systems to manage condensation and corrosion issues in such a way that they do not interfere with the process.

It is noted that FIG. 1 illustrates a line of 7 batch ovens 5. The invention is not confined to this number of batch ovens 5. Typically, the number of batch ovens 5 is 6-10 ovens. However, in any given situation, the number of batch ovens 5 in a cluster will be a function of oven size and physical constraints of arranging batch ovens and gas collection and sharing equipment in an efficient arrangement.

It is noted that FIG. 1 shows the batch ovens 5 in a line. The invention is not confined to this array of batch ovens 5.

The batch ovens 5 may be any suitable form. By way of example, the batch ovens 5 may be a non-recovery coke-oven style oven, with the bed of ore-biomass briquettes being charged into an oven prior to the commencement of a batch cycle and pushed out of the oven at the end of a batch cycle.

Ore and biomass should preferably be in close contact with one another for this process to work efficiently. Any method of achieving this may be used, briquetting being just one example. Other options may involve ore-biomass mixing followed by roll pressing into slabs that break up naturally (or are deliberately broken up) prior to charging. It may also be possible to use some form of non-agglomerated charge into the ovens such as alternate layering of ore and biomass (somewhat akin to stamp-charging).

For illustration purposes the following description uses ore-biomass briquettes.

The briquettes may be manufactured by any suitable method. By way of example, measured amounts of iron ore fines and biomass and water (which may be at least partially present as moisture in the biomass) and optionally flux is charged into a suitable size mixing drum (not shown) and the drum rotated to form a homogeneous mixture. Thereafter, the mixture may be transferred to a suitable briquette-making apparatus and cold-formed into briquettes.

In one embodiment of the invention, the briquettes are roughly 20 cm³ in volume and contain 30-40% biomass (e.g. elephant grass at 20% moisture). A small amount of flux material (such as limestone) may be included, with the balance comprising iron ore fines.

In one embodiment of the invention, the process begins with a layer of (typically) 800 mm deep ore-biomass briquettes charged into a batch oven 5.

During an initial heating phase of the method, heating produces only water (i.e. nothing combustible to support a flame). However, later in the heating process the briquette bed will over-produce fuel gas. At this point, excess fuel gas may be harvested (for example, from wall downcomers of the batch oven 5) as described above via pipes 11 transferring fuel gas to the header 7 for use in other batch ovens 5 at different, fuel gas-deficient stages of the process.

Once the batch process cycle is complete in a batch oven, the briquette bed is pushed out of the batch oven 5 in a similar way to that for coke in a coke oven.

The physical structure of the solid DRI product at the end of the process is not critical.

The physical structure of the product may be friable and break easily or it could resemble a robust 3D “chocolate bar”.

Either way, with further reference to FIG. 1, the solid DRI product is pushed it into an insulated chamber (not shown in FIG. 1) which is then physically transported (hot) to a downstream electric melting furnace 17. Here a feed system (not shown in FIG. 1) will accept the hot chamber and pass it through a system of (for example) pushers and breaker bars (not shown in FIG. 1) in order to feed it into the bath.

It is noted that those structural components that are not specifically shown in FIG. 1 are standard components and the skilled person would be able to make an appropriate selection of the components.

It is noted that there is no requirement to break up the solid DRI product completely to supply to the electric melting furnace 17—only into lumps small enough to constitute more or less steady feed into the furnace from a metallurgical control point of view. It is expected that fairly large lumps (e.g. 20-30 briquettes clumped together) could pass through such a system without causing any issues.

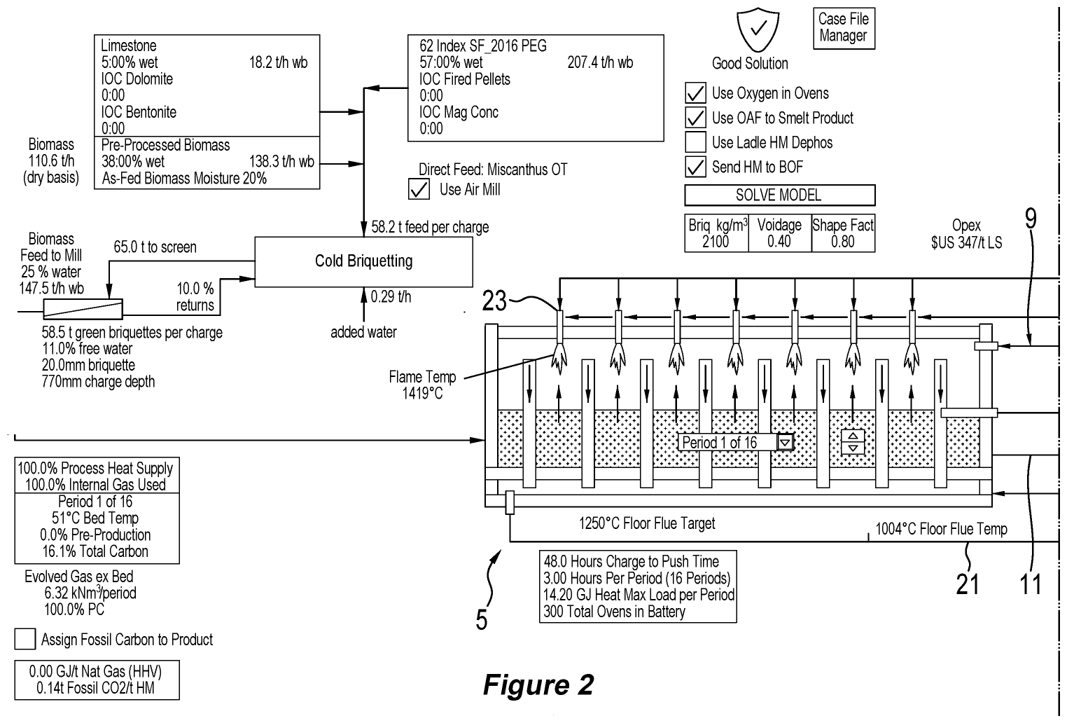

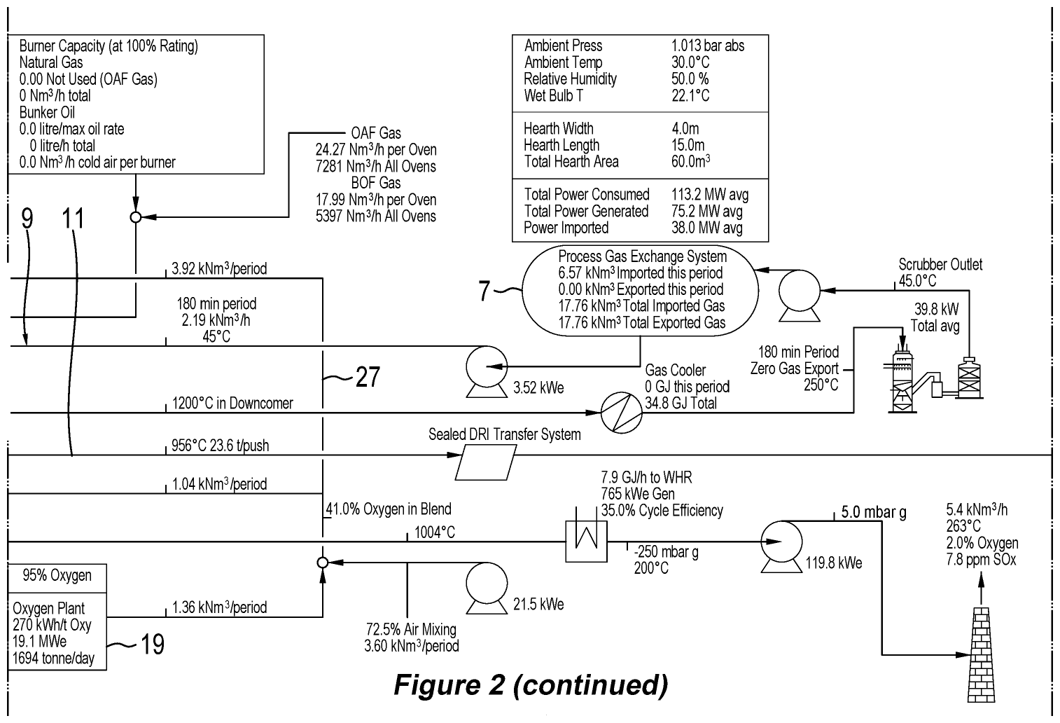

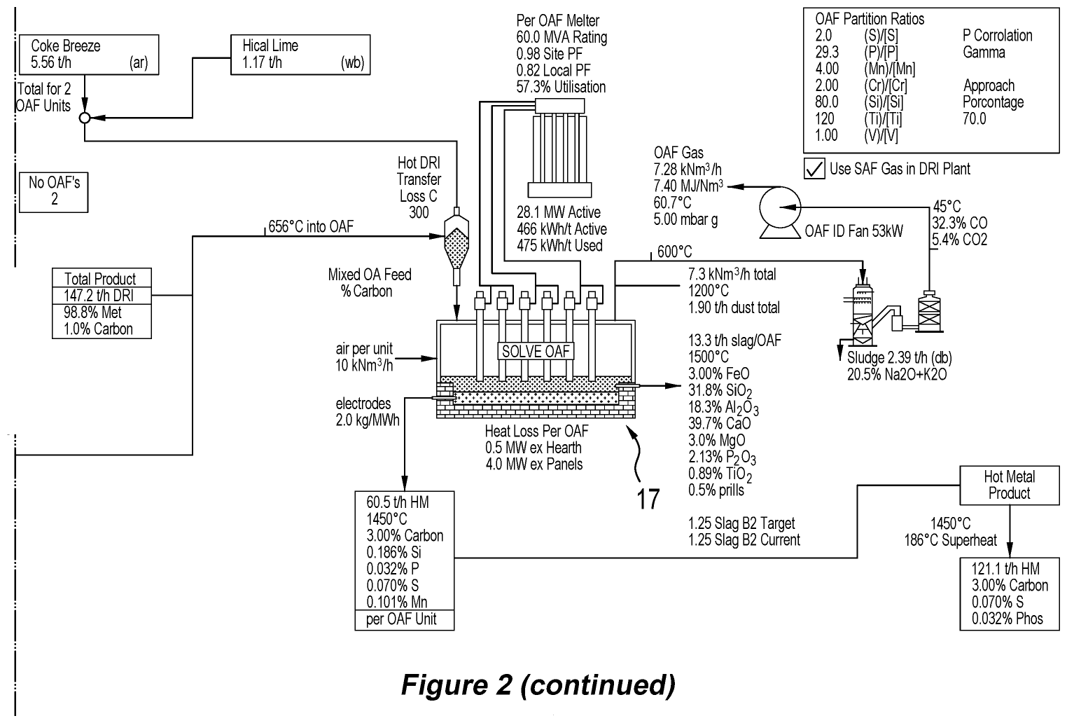

FIGS. 2-4 are process flowsheet diagrams illustrating one embodiment of a process and apparatus for producing direct reduced iron (“DRI”) from cold-formed briquettes of iron ore and biomass in one of the batch ovens 5 of FIG. 1.

The process flowsheet diagrams of FIGS. 2-4 also illustrate transferring the DRI product from the batch oven 5 to an electric melting furnace 17 and operating the furnace to produce molten metal, in accordance with one embodiment of a process and apparatus for producing molten metal (such as cold pig iron or steel) from DRI.

The data in the diagrams of FIGS. 2-4 is derived from a model developed by the applicant.

The process and apparatus shown in FIG. 2 illustrates the start of an embodiment of an oven heating cycle (the first 3 hours of a 48-hour cycle) for one batch oven 5.

It is noted that the oven heating cycle of FIGS. 2-4 may apply to any one of the batch overs 5 in the array shown in FIG. 1. It is also noted that the start times of the oven heating cycles for the batch ovens 5 shown in FIG. 1 may be staggered to match the fuel gas generation and fuel gas supply requirements across the batch ovens 5. It is also noted that different oven heating cycles may be used in the batch ovens 5 in FIG. 1 to optimise operational efficiency in relation to fuel gas utilisation (or other factors, such as upstream briquette production and supply factors and downstream hot metal production factors).

With further reference to FIG. 2, in the described embodiment, a 59-tonne cold-formed briquette bed is charged into a batch oven 5 that is 4 m wide by 15 m deep (800 mm bed depth). The briquettes comprise 38% elephant grass at 20% water, 5% limestone and 57% Pilbara Blend iron ore fines. The bed is cold and only water vapour is released during the first 3-hour period of the batch cycle. Fuel gas is drawn from other batch ovens 5 (see FIG. 1) that are in the “fuel production” stages of their cycle as part of a process gas exchange system 7. The fuel gas, supplied to batch oven 5 via a line 9, is burned with an air-oxygen mixture containing 41% oxygen in burners 23 in batch oven 5. Oxygen is produced via cryogenic air separation in an oxygen plant 19 in a conventional way and supplied to the burners via a line 27. Offgas generated in the batch oven 5 is discharged from the batch oven and transferred via a line 21 for downstream processing and release to the atmosphere.

Downstream processing of DRI briquettes produced in the batch oven 5 involves melting the DRI in an electric furnace (OAF) 17 to produce hot metal, followed by conversion to steel in a BOF. Both the OAF and the BOF generate combustible fuel gas streams—although small in terms of overall energy demand—and these gas streams are nevertheless used in the batch oven burners as supplementary fuel.

In this 3-hour period (as shown in FIG. 2) 6570 Nm³ fuel gas is imported from other batch ovens, augmented by 72.9 Nm³ OAF gas and 54.0 Nm³ BOF gas.

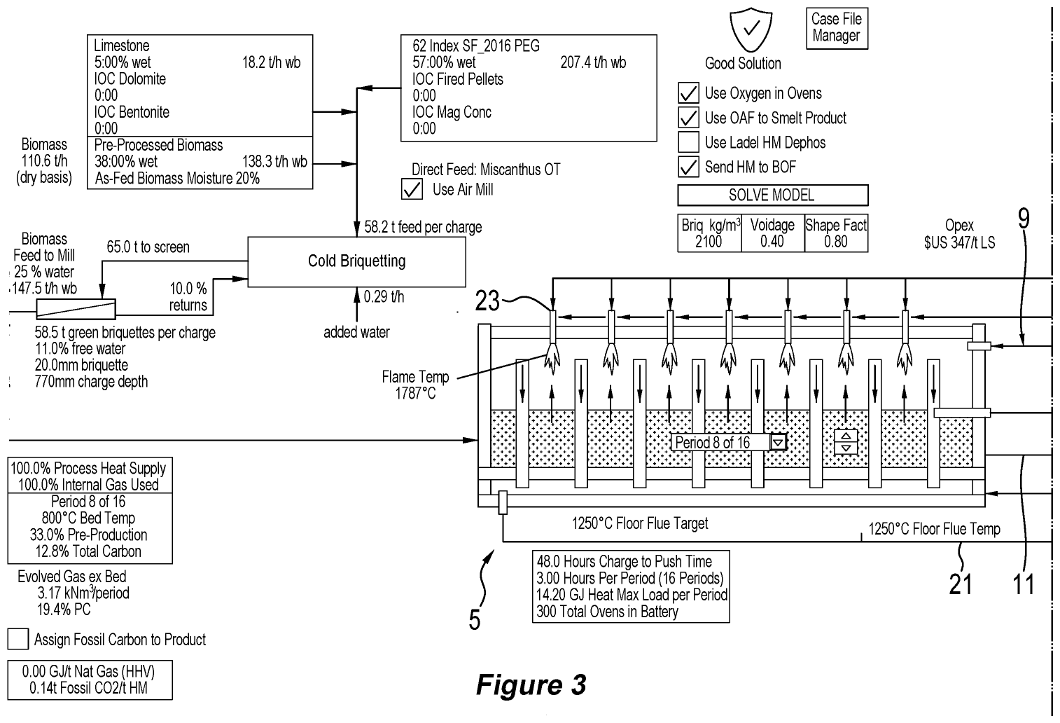

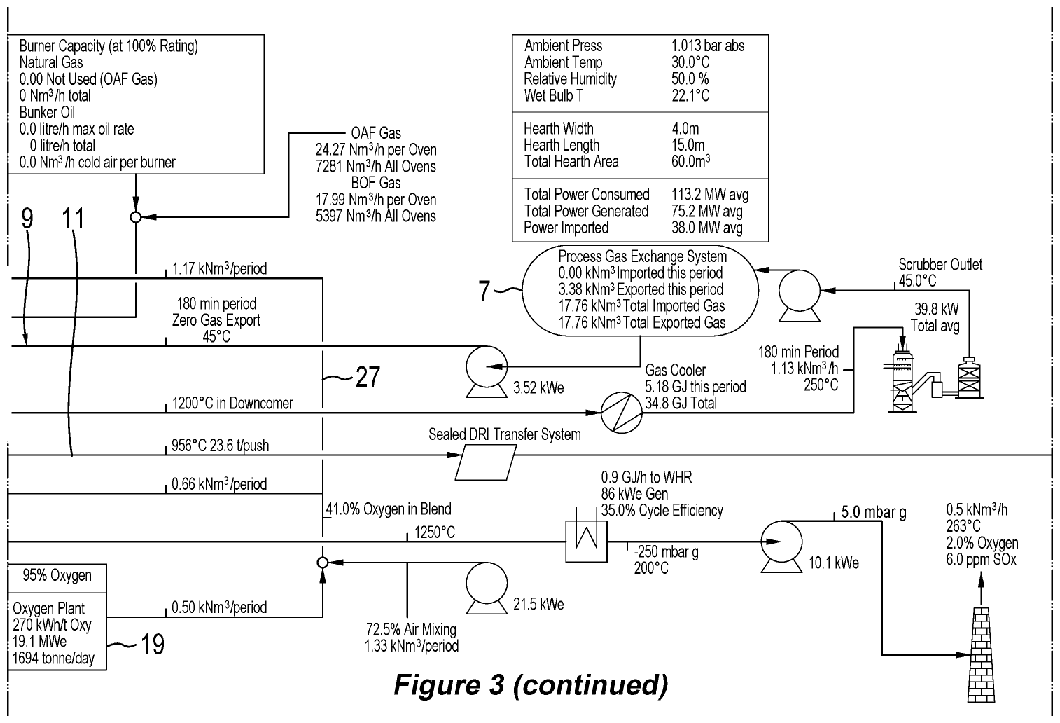

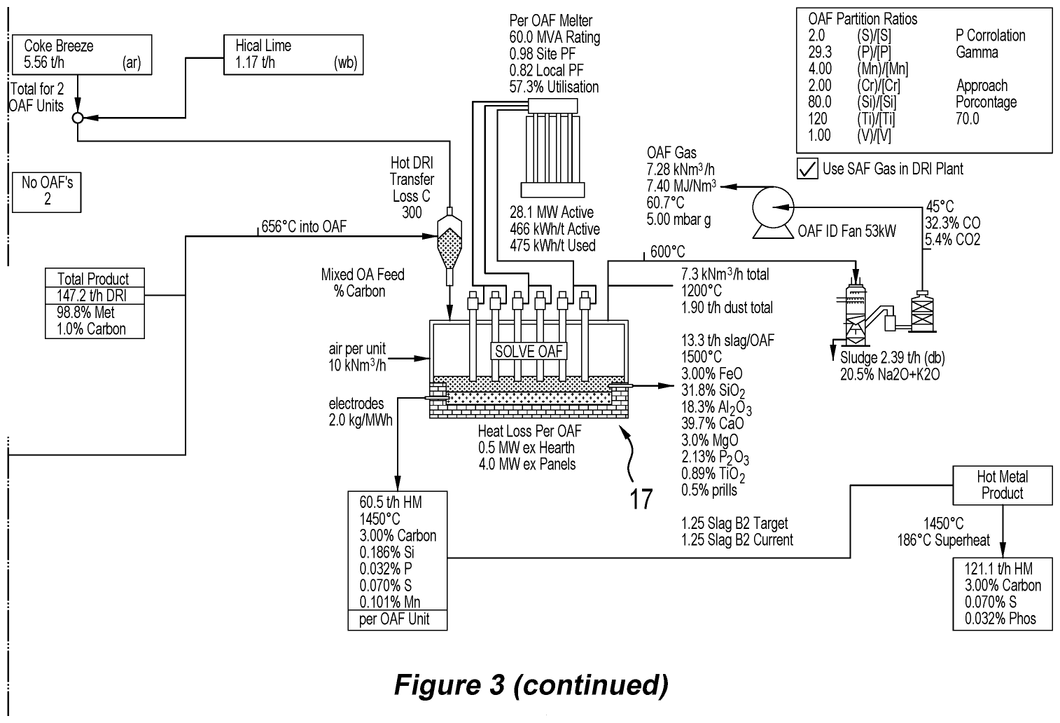

FIG. 3 shows a 3-hour period in the middle of the 48-hour batch cycle when fuel gas is being produced in the batch oven 5 shown in the Figure. At this stage, the bed is around 800° C. and fuel gas production exceeds requirements by 3380 Nm³/3 h. This excess is exported to the communal header 7 for use by other batch ovens 5.

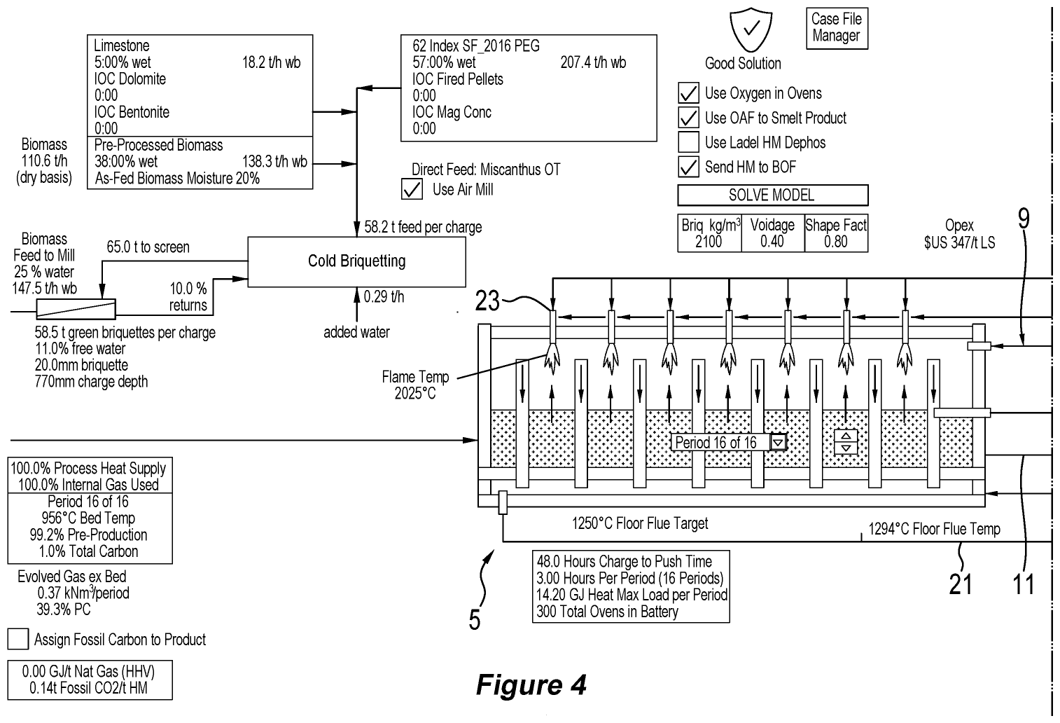

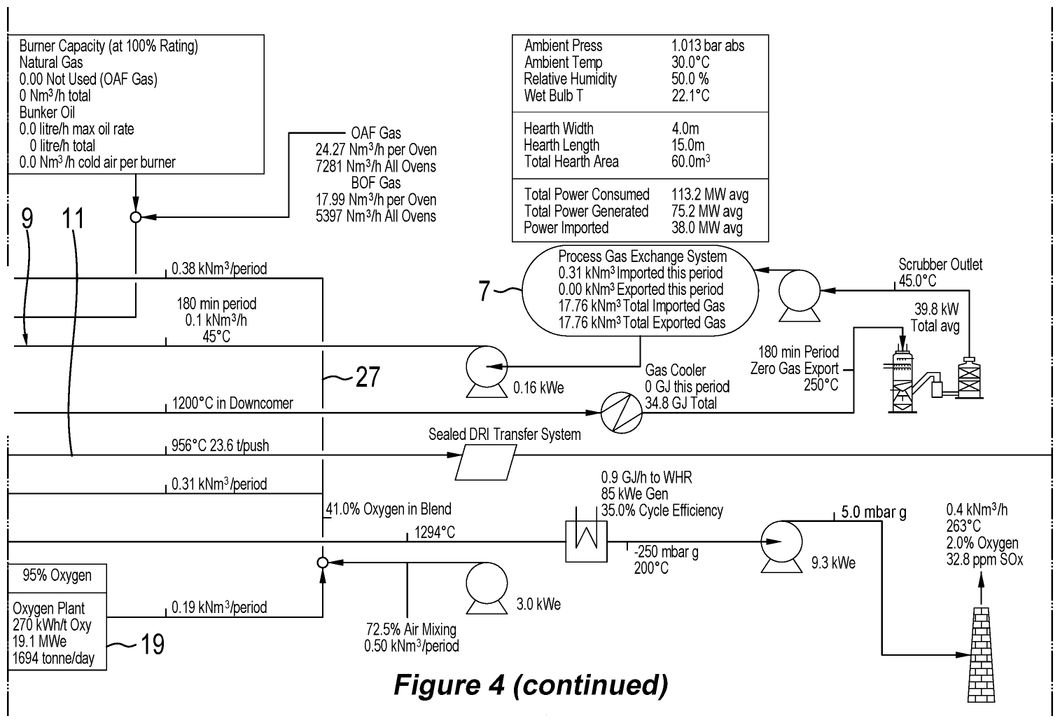

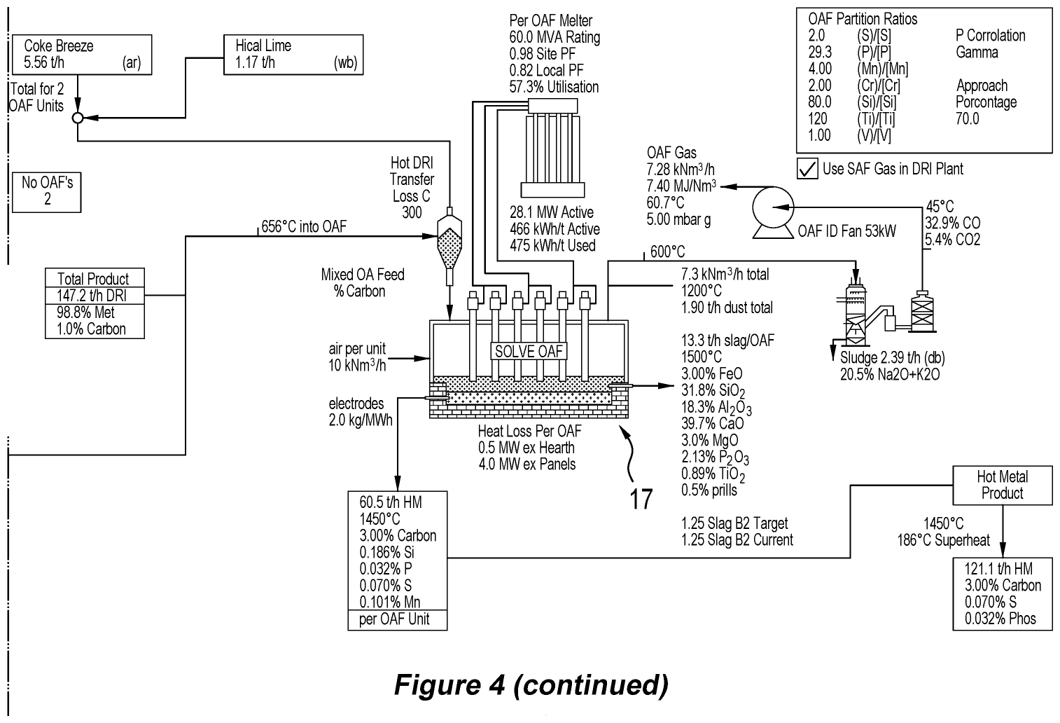

FIG. 4 shows the final 3 hours of the 48-hour batch cycle. At this point the bed has reached 956° C. and metallisation is around 98-99%. In this instance a small amount of imported fuel gas (310 Nm³/3 h) is needed to sustain a thermal balance.

This example necessarily contains multiple assumptions regarding kinetic parameters—precise details may shift as a result of different kinetics. However, the principles are not expected to change—in particular, the sharing of fuel gas between batch ovens 5 within an oven cluster (see FIG. 1) such that each oven 5 produces and receives the same amount of fuel gas in the overall integrated cycle. Although the current example is based on a constant air-oxygen blend to the gas burners (41% oxygen by volume), it is expected that the ratio of air to oxygen could be varied as an additional control parameter to further optimise the process.

Around 60-70% of the required plant electric power (including power needed for the electric melting furnace and the oxygen plant) is generated from residual heat in the flue gas (and fuel gas) from the ovens. A possible alternative is to dispense with oxygen and run the process using preheated air instead. Air preheat functions in much the same way as oxygen enrichment from an energy balance point of view—heat for air preheating could be obtained from the hot flue stream using (for example) pebble heaters. This variation is expected to have similar overall performance characteristics, but control may be more difficult given the lower degree of operational agility.

After the final 3 hours of the 48-hour batch cycle has elapsed the bed is pushed out form the batch oven 5 and transferred to the OAF unit 17 (which may operate in either submerged-arc or open-arc mode, the name notwithstanding). Flux and coke breeze are added in the OAF 17 to control metal carbon and slag chemistry. Hot metal (molten pig iron in this embodiment) is produced. This may be cooled and cast into pigs or passed directly (in liquid form) to a steelmaking vessel (BOF or EAF).

Many modifications may be made to the embodiment described above without departing from the spirit and scope of the invention.

By way of example, whilst the embodiment shown in FIGS. 2-4 includes a 59-tonne cold-formed briquette bed that is charged into a batch oven 5 that is 4 m wide by 15 m deep (800 mm bed depth), with the briquettes comprising 38% elephant grass at 20% water, 5% limestone and 57% Pilbara Blend iron ore fines, it can readily be appreciated the invention is not confined to this size briquette bed with this composition of the briquettes.

### References

1. Vogl, V et al, Assessment of hydrogen direct reduction for fossil-free steelmaking, Journal of Cleaner production 203 (218) 736-745
2. Strezov, V, Iron ore reduction using sawdust: experimental analysis and kinetic modelling, renewable Energy 31 (12) 1892-1905, October 2006
3. Madias, J and De Cordova, M, Nonrecovery/heat recovery cokemaking: a review of recent developments, AISTech 2011 proceedings Vol 1 235-251

1. A process for producing direct reduced iron (“DRI”) from iron ore and biomass that includes heating a batch of iron ore and biomass in a batch oven in a temperature range of 700-1100° C. in a batch cycle time of 10-100 hours and reducing iron ore and forming a solid DRI product having a metallisation of 80-99%, typically 90-99%, and generating an offgas and discharging the solid product at the end of the batch cycle and discharging offgas during the course of the batch cycle.

2. The process defined in claim 1 wherein the batch oven is a static oven.

3. The process defined in claim 1 includes heating the batch of iron ore and biomass via heat generated by the combustion of a fuel gas in a top space of the batch oven.

4. The process defined in claim 1 includes heating the batch of iron ore and biomass via heat generated by the combustion of a fuel gas in a bottom space of the batch oven.

5. The process defined in claim 1 includes heating the batch of iron ore and biomass via heat generated by the combustion of a fuel gas with a nominally cold oxygen-air mixture with a minimum of 25% oxygen in the air-oxygen mixture (calculated as a mixed stream regardless of whether or not air and oxygen are (a) actually pre-mixed or (b) fed independently as two individual streams to the gas burners).

6. The process defined in claim 1 includes heating the batch of iron ore and biomass via heat generated by the combustion of a fuel gas with hot air in a temperature range 400-1200° C.

7. The process defined in claim 1 includes heating the batch of iron ore and biomass via heat generated by the combustion of a fuel gas with a combination of hot air (in a temperature range 25-1200° C.) and cold oxygen, where hot air and oxygen are either pre-blended or fed as individual streams to gas burners.

8. The process defined in claim 1 wherein the percentage of biomass in the batch as supplied to the batch oven is 20-50% by weight on a wet (as-charged) basis of the total weight of the batch.

9. The process defined in claim 8 wherein the balance of the batch as supplied to the batch oven is (a) iron ore and (b) flux/binder materials and (c) optionally carbonaceous material, which may be coal or pre-charred biomass, in an amount of <5% by weight of the total weight of the batch.

10. The process defined in claim 1 wherein the percentage of biomass in the batch as supplied to the batch oven is 30-40% by weight on a wet (as-charged) basis of the total weight of the batch.

11. The process defined in claim 10 wherein the balance of the batch as supplied to the batch oven is (a) iron ore and (b) flux/binder materials and (c) optionally carbonaceous material, which may be coal or pre-charred biomass, in an amount of <5% by weight of the total weight of the batch.

12. The process defined in claim 1 includes heating iron ore and biomass to 800-1000° C. in the batch cycle time and reducing iron ore to a metallisation of 85-98%.

13. The process defined in claim 1 wherein the batch cycle time is 30-60 hours.

14. The process defined in claim 1 wherein the iron ore and biomass in the batch of iron ore and biomass are layered in the batch oven, such that there is at least one layer of iron ore between one preceding and one succeeding layer of biomass.

15. The process defined in claim 1 wherein the iron ore and biomass in the batch of ore and biomass are premixed when forming the batch to avoid non-uniform reduction zones in the batch in the batch oven.

16. The process defined in claim 1 wherein the batch of ore and biomass includes briquettes of iron ore and biomass to avoid non-uniform reduction zones in the batch in the batch oven.

17. The process defined in claim 1 includes operating a plurality of the batch ovens and using at least a part of an offgas discharged from at least some of the plurality of the batch ovens as an energy source, i.e. a fuel gas, in other batch ovens in the plurality of the batch ovens to balance heat supply and demand requirements.

18. (canceled)

19. The process defined in claim 1 includes transferring the solid product (typically, whilst hot) from the batch oven in the case of claims 1 to 16 or from the plurality of the batch ovens in the case of claims 17 and 18 to an electric melting furnace and processing the solid product in the electric melting furnace and producing molten metal, such as pig iron or steel, and an offgas.

20. The process defined in claim 19 includes using the electric arc furnace fuel gas an energy source in the batch oven.

21. A process for producing direct reduced iron (“DRI”) from iron ore and biomass that includes operating a plurality of batch ovens in accordance with the process defined in claim 1, using at least a part of an offgas discharged from at least one batch oven as an energy source, i.e. a fuel gas, in at least one other batch oven, and controlling the batch cycles and operating conditions in the batch ovens to balance heat supply and demand requirements across the batch ovens.

22. A process for producing molten metal from DRI that includes operating the process defined in claim 21 and producing a solid DRI product and transferring the solid DRI product to an electric melting furnace and processing the solid product in the electric melting furnace and producing molten metal, such as pig iron or steel.

23. An apparatus for producing direct reduced iron (“DRI”) that includes a plurality of batch ovens for producing batches of DRI from batches of iron ore and biomass, a gas collection and gas sharing assembly interconnecting the batch ovens, the gas collection and sharing assembly including a communal header and pipes extending between the batch ovens and the header for supplying fuel gas to the header and supplying fuel gas from the header to the batch ovens.

24. An apparatus for producing molten metal from a solid DRI product includes the apparatus for producing a direct reduced iron (“DRI”) product defined in claim 23 and an electric melting furnace for producing molten metal, such as pig iron or steel from the solid DRI product.
